(19) United States
(12) Patent Application Publication
(10) Pub. No.: US 2026/0367361 A1
(43) Pub. Date: Nov. 19, 2026

(54) FULL-FRAME LARGE APERATURE LENS

(71) Applicant: GUANGDONG SIRUI OPTICAL CO., LTD, Zhongshan (CN)

(72) Inventors: Jie Li, Zhongshan (CN); Kunyi Lin, Zhongshan (CN); Haoer Xing, Zhongshan (CN)

(73) Assignee: GUANGDONG SIRUI OPTICAL CO., LTD, Zhongshan (CN)

(21) Appl. No.: 19/256,148

(22) Filed: Jul. 1, 2025

(30) Foreign Application Priority Data
May 15, 2025 (CN) 202510629140.3
May 15, 2025 (CN) 202520963203.4

(51) Int. Cl. G02B 13/00; G02B 7/02

(52) U.S. Cl. CPC G02B 13/0045; G02B 7/025; G02B 13/006

(57) ABSTRACT

A full-frame large-aperture lens includes four lens groups arranged sequentially from the object side to the image side along the optical axis: the first, second, third, and fourth lens groups. The focal lengths of these lens groups satisfy the following conditions: −3.2<f(G1)/(f(G2−G4))<−1.7; −3.4<f(G3)/(f(G2−G4))<−1.9; −3.3<f(G1)/(f(G2−G4))<−1.8; 1.3<f(G4)/(f(G2−G4))<2.5. This lens corrects various aberrations across different wavelength bands, ensuring sufficient resolution in both the center and peripheral fields of view. It features a simple structure, compact size, and a large aperture, and can achieve high-resolution imaging from infinity to close distances.

### TECHNICAL FIELD

Aspects of the invention generally relate to the field of optical lens technology, and in particular to a full-frame aperture lens.

### BACKGROUND

In recent years, while mobile phones have replaced card cameras for everyday photography, mirrorless cameras offer a more extensive photography experience for enthusiasts with higher demands. These cameras are compact, lightweight, easy to carry, and feature larger image sensors and apertures, which enhance background blur effects.

The existing full-frame large aperture lens has various aberrations and low resolution in some bands.

### SUMMARY

Therefore, aspects of the invention attempt to overcome existing technology by offering technical solutions to cure defects of various aberrations, low resolution and high cost in the imaging of some bands by a full-frame large-aperture lens with various features in embodiments of the invention.

In one example, aspects of the invention provide technical solutions as follows:

A full-frame large-aperture lens may include a first lens group, a second lens group, a third lens group and a fourth lens group arranged sequentially from the object side to the image side along the optical axis; the focal length of all lens groups satisfies the following condition formula:

−3.2<f(G1)/f(G2−G4)<−1.7;

−3.4<f(G3)/f(G2−G4)<−1.9;

−3.3<f(G1)/f<−1.8; and

1.3<f(G4)/f(G2−G4)<2.5;

In one example, f(G1) represents the focal length of the first lens group, f(G2−G4) represents the combined focal length of the second to fourth lens groups, f(G3) represents the focal length of the third lens group, f(G4) represents the focal length of the fourth lens group, and f represents the combined focal length of all lens groups.

Further, in some embodiments, an aperture may be provided between the first lens group and the second lens group, and the third lens group may be moved along the optical axis to achieve focusing.

Further, in some embodiments, the first lens group comprises a first lens, a second lens, a third lens, a fourth lens, a fifth lens, a sixth lens and a seventh lens arranged sequentially from the object side to the image side along the optical axis;

In some embodiments, the first lens may be a crescent-shaped negative refractive power lens with a convex surface facing the object side;

The second lens may be a crescent-shaped positive refractive power lens with the convex surface facing the object side;

The third lens may be a crescent-shaped negative refractive power lens with a convex surface facing the object side;

The fourth lens may be a crescent-shaped negative refractive power lens with the convex surface facing the image side;

The fifth lens may be a double convex positive focal power lens;

The sixth lens may be a double concave negative optical power lens; The seventh lens may be a double convex positive focal power lens;

In this case, the adjacent surfaces of the second lens and the third lens are bonded together; and the adjacent surfaces of the sixth lens and the seventh lens are bonded together.

Further, the second lens group includes an eighth lens; the eighth lens may be a double convex positive refractive power lens.

Further, the third lens group includes a ninth lens; the ninth lens may be a crescent-shaped negative refractive power lens with a convex surface facing the object side.

Further, the fourth lens group comprises a tenth lens, an eleventh lens, a twelfth lens, a thirteenth lens, a fourteenth lens, a fifteenth lens and a sixteenth lens arranged sequentially from the object side to the image side along the optical axis;

The tenth lens may be a crescent-shaped negative light focal power lens with the convex surface facing the object side;

The eleventh lens may be a double convex positive refractive power lens;

The twelfth lens may be a double convex positive focal power lens;

The thirteenth lens may be a double concave positive focal power lens;

The fourteenth lens may be a crescent positive focal power lens;

The fifteenth lens may be a double convex positive focal power lens;

The sixteenth lens may be a double concave positive focal power lens.

The tenth lens and the eleventh lens are bonded together on their adjacent side; the twelfth lens and the thirteenth lens are bonded together on their adjacent side; and the fifteenth lens and the sixteenth lens are bonded together on their adjacent side.

Furthermore, the fifth, ninth, and fourteenth lenses are all aspherical lenses, while the first to twelfth lenses are all spherical lenses.

Further, the aperture of the full-frame large-aperture lens may be 1-1.6, and the field of view Angle 2ω of the full-frame large-aperture lens may be 55°-75°.

Further, the focal length of the full-frame aperture lens may be 20 mm to 40 mm.

Furthermore, the total optical length of the full-frame large aperture lens does not exceed 110 mm.

The technical solution of this invention has the following advantages: This full-frame, large-aperture lens corrects various aberrations across different wavelength bands, ensuring sufficient resolution in both the center and peripheral fields of view. It features a simple structure, compact size, and a large aperture, and can achieve high-resolution imaging from infinity to close range.

### BRIEF DESCRIPTION OF THE DRAWINGS

To better illustrate the specific embodiments of this invention or the technical solutions in existing technologies, the following may be a brief introduction to the drawings used in the description. It may be evident that the drawings described below are some embodiments of this invention. Those skilled in the art may also derive additional drawings from these without undue experimentation.

FIG. 1 may be a sectional structure schematic diagram of the full-frame large aperture lens according to one embodiment of the invention.

FIG. 2 may be a field curvature diagram of the full-frame large aperture lens according to one embodiment of the invention.

FIG. 3 shows a distortion of the full-frame large aperture lens according to one embodiment of the invention.

Reference characters used in the figures: G1: a first lens group; G2: a second lens group; G3: a third lens group; G4: a fourth lens group; 1: a first lens; 2: a second lens; 3: a third lens; 4: a fourth lens; 5: a fifth lens; 6: a sixth lens; 7: a seventh lens; 8: an eighth lens; 9: a ninth lens; 10: a tenth lens; 11: an eleventh lens; 12: a twelfth lens; 13: a thirteenth lens; 14: a fourteenth lens; 15: a fifteenth lens; 16: a sixteenth lens.

### DETAILED DESCRIPTION

The following disclosure provides a clear and complete description of possible the technical solution of aspects of the invention, in conjunction with the accompanying drawings. Clearly, the described embodiments are part of the invention, not all of them. Based on the embodiments of this invention, all other embodiments that may be obtained by those skilled in the art without making inventive efforts are also within the scope of protection of this invention.

In the description of this invention, it may be important to note that terms such as “center,” “up,” “down,” “left,” “right,” “vertical,” “horizontal,” “inside,” and “outside” indicate directions or positions based on the orientation shown in the drawings. These terms are used for convenience and simplification, not to suggest that the devices or components must be constructed or operated in a specific direction. Therefore, these terms should not be interpreted as limiting the invention. Additionally, terms like “first,” “second,” and “third” are used for descriptive purposes and do not imply any relative importance.

In the description of this invention, it should be noted that unless otherwise specified, the terms “installation,” “connection,” and “linking” should be interpreted broadly. For example, they can refer to fixed connections, removable connections, or integral connections; they may be mechanical or electrical connections; they may be direct or indirect through an intermediary, or internal connections between two components. For those skilled in the field, these terms may be understood in specific contexts within this invention.

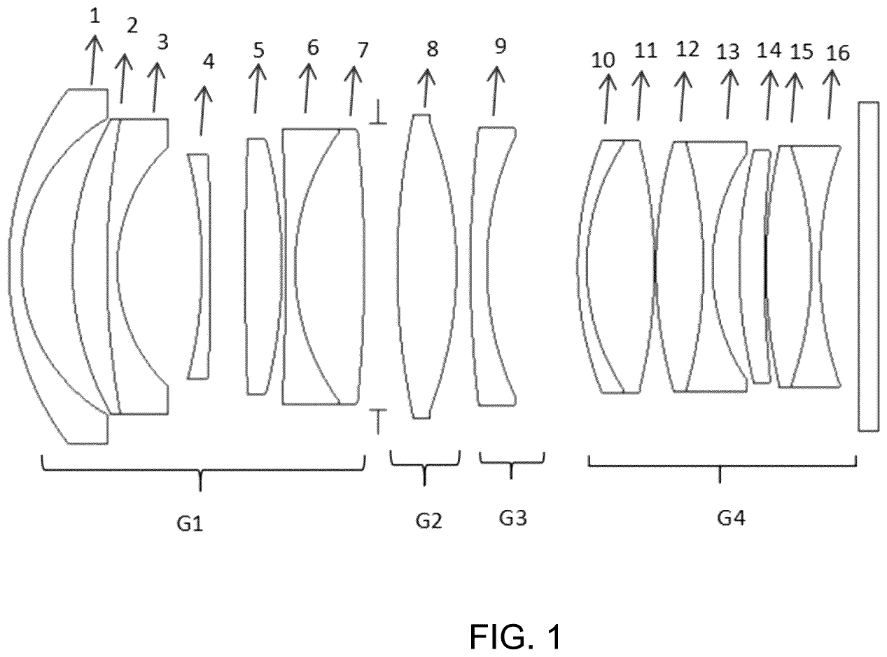

As shown in FIG. 1, a full-frame large-aperture lens includes a first lens group G1, a second lens group G2, a third lens group G3 and a fourth lens group G4 arranged sequentially from the object side to the image side along the optical axis; the focal length of all lens groups satisfies the following condition formula:

−3.2<f(G1)/f(G2−G4)<−1.7;

−3.4<f(G3)/f(G2−G4)<−1.9;

−3.3<f(G1)/f<−1.8; and

1.3<f(G4)/f(G2−G4)<2.5;

Among them, f(G1) represents the focal length of the first lens group G1, f(G2−G4) represents the combined focal length of the second lens group G2 to the fourth lens group G4, f(G3) represents the focal length of the third lens group G3, f(G4) represents the focal length of the fourth lens group G4, and f represents the combined focal length of all lens groups.

In this embodiment, the first lens group G1 comprises lenses 1 through 7 arranged sequentially from the object side to the image side along the optical axis. Specifically, lens 1 may be a convex meniscus lens with negative refractive power facing the object side; lens 2 may be a convex meniscus lens with positive refractive power facing the object side; lens 3 may be a convex meniscus lens with negative refractive power facing the object side; lens 4 may be a convex meniscus lens with negative refractive power facing the image side; lens 5 may be a biconvex lens with positive refractive power; lens 6 may be a biconcave lens with negative refractive power; and lens 7 may be a biconvex lens with positive refractive power.

In some embodiments, the second lens group G2 includes the eighth lens 8, which may be a double convex positive refractive power lens. The third lens group G3 includes the ninth lens 9, which may be a crescent-shaped negative refractive power lens with the convex surface facing the object side.

In some embodiments, the fourth lens group G4 comprises the tenth to sixteenth lenses, arranged from the object side to the image side along the optical axis: the tenth lens 10, the eleventh lens 11, the twelfth lens 12, the thirteenth lens 13, the fourteenth lens 14, the fifteenth lens 15, and the sixteenth lens 16. Specifically, the tenth lens 10 may be a convex-curved negative refractive power lens facing the object side; the eleventh lens 11 and the twelfth lens 12 are both double-convex positive refractive power lenses; the thirteenth lens 13 may be a double-concave positive refractive power lens; the fourteenth lens 14 may be a convex-curved positive refractive power lens; the fifteenth lens 15 may be a double-convex positive refractive power lens; and the sixteenth lens 16 may be a double-concave positive refractive power lens.

In some embodiments, an aperture may be provided between the first lens group G1 and the second lens group G2, and the third lens group G3 may be moved along the optical axis to achieve focusing. The third lens group G3 has only a single ninth lens 9 as the focusing function, which makes focusing more convenient and simple.

In some embodiments, the fifth lens 5, ninth lens 9, and fourteenth lens 14 are all aspherical lenses, while the first lens 1, second lens 2, third lens 3, fourth lens 4, sixth lens 6, seventh lens 7, eighth lens 8, tenth lens 10, eleventh lens 11, twelfth lens 12, and thirteenth lens 13 are all spherical lenses. This design effectively corrects spherical aberration and field curvature, reducing the overall weight of the lens.

In some embodiments, the second lens 2 and the third lens 3 are bonded together on their adjacent sides. Similarly, the sixth lens 6 and the seventh lens 7, the tenth lens 10 and the eleventh lens 11, the twelfth lens 12 and the thirteenth lens 13, and the fifteenth lens 15 and the sixteenth lens 16 are bonded together on their adjacent sides. This bonded lens assembly effectively corrects chromatic aberration, making the captured images more vivid and true to life.

In some embodiments, the aperture of the full-frame large-aperture lens ranges from 1 to 1.6, and its focal length may be between 20 mm and 40 mm. The field of view (2ω) of the lens may be 55° to 75°. The total optical length of the lens does not exceed 110 mm.

In some embodiments, the relevant parameters of each lens are shown in Table 1 below:

TABLE 1

| | | Radius | Thickness | Refractive | Abbe |
|---|---|---|---|---|---|
| | Lens | R | D | index | number |
| Lens | type | (mm) | (mm) | Nd | Vd |
| First lens | spherical | 33.981 | 1.94 | 1.683 | 57.92 |
| | surface | | | | |
| | spherical | 22.741 | 6.63 | | |
| | surface | | | | |
| Second lens | spherical | 56.558 | 4.91 | 2.143 | 22.04 |
| | surface | | | | |
| Third lens | spherical | 101.235 | 1.31 | 1.496 | 75.62 |
| | surface | | | | |
| | spherical | 21.061 | 10.68 | | |
| | surface | | | | |
| Fourth lens | spherical | -79.673 | 1.09 | 1.785 | 27.28 |
| | surface | | | | |
| | spherical | -625.638 | 4.86 | | |
| | surface | | | | |
| Fifth lens | spherical | 393.007 | 6.19 | 1.930 | 34.75 |
| | surface | | | | |
| | aspherical | -65.631 | 0.43 | | |
| | surface | | | | |
| Sixth lens | spherical | -376.285 | 1.22 | 1.885 | 22.57 |
| | surface | | | | |
| The seventh | spherical | 30.073 | 5.46 | 1.654 | 64.03 |
| lens | surface | | | | |
| | spherical | -193.608 | 1.73 | | |
| | surface | | | | |
| aperture slot | aperture | infinity | 2.06 | | |
| | slot | | | | |
| The eighth lens | spherical | 83.200 | 8.16 | 1.804 | 55.16 |
| | surface | | | | |
| | spherical | -29.097 | 1.64 | | |
| | surface | | | | |
| Ninth lens | spherical | 140.809 | 2.07 | 1.513 | 69.61 |
| | surface | | | | |
| | aspherical | 39.457 | 10.48 | | |
| | surface | | | | |
| The tenth lens | aperture | 40.908 | 1.10 | 1.754 | 22.67 |
| | slot | | | | |
| The eleventh | spherical | 26.971 | 8.02 | 1.491 | 70.59 |
| lens | surface | | | | |
| | spherical | -54.959 | 0.19 | | |
| | surface | | | | |
| Twelfth lens | spherical | 48.487 | 5.61 | 1.754 | 16.17 |
| | surface | | | | |
| The thirteenth | spherical | -54.962 | 1.05 | 1.755 | 20.59 |
| lens | surface | | | | |
| | spherical | 24.744 | 3.27 | | |
| | surface | | | | |
| Fourteenth lens | aspherical | 51.562 | 2.99 | 1.718 | 40.56 |
| | surface | | | | |
| | spherical | 115.583 | 0.19 | | |
| | surface | | | | |
| The fifteenth | spherical | 58.316 | 5.35 | 1.445 | 59.00 |
| lens | surface | | | | |
| Sixteenth lens | spherical | -38.584 | 1.02 | 1.579 | 22.58 |
| | surface | | | | |
| | spherical | 38.584 | 4.55 | | |
| | surface | | | | |
| | spherical | Infinity | 2.5 | 1.52 | 64.20 |
| | surface | | | | |
| | spherical | Infinity | 13.5 | | |
| | surface | | | | |

As shown in FIG. 1, according to embodiments of the invention, the ninth lens 9 may be moved along the optical axis between the eighth lens 8 and the tenth lens 10 to focus. Since the ninth lens 9 may be focused inside, the overall length of the lens may be kept unchanged when the focal length of the lens may be adjusted.

In some embodiments, the full-frame aperture lens corrects various aberrations in each band, so that the central and edge field of view have enough resolution. It has the advantages of simple structure, small size and large aperture, and can achieve high resolution imaging from infinity to close distance.

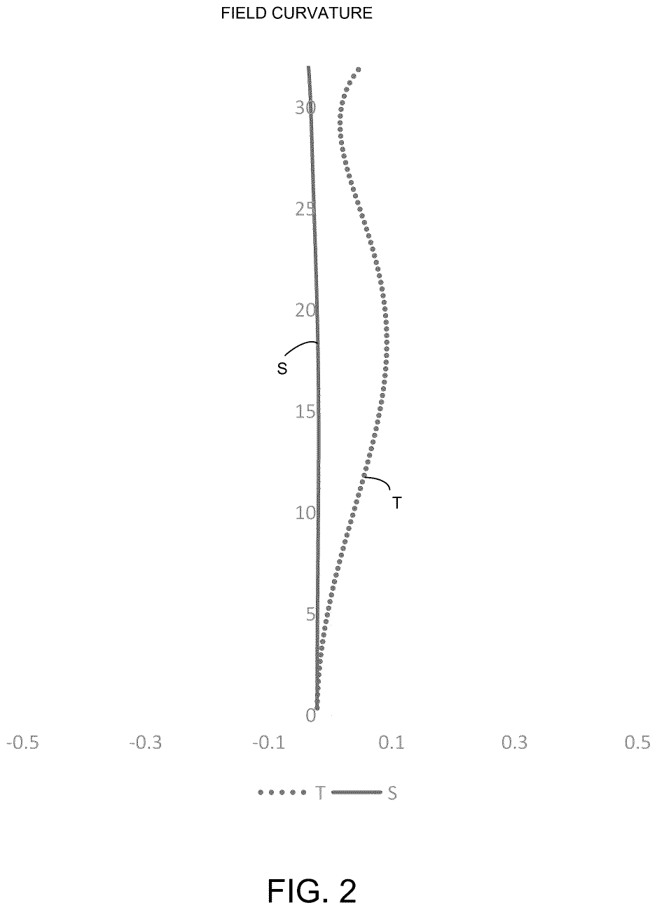

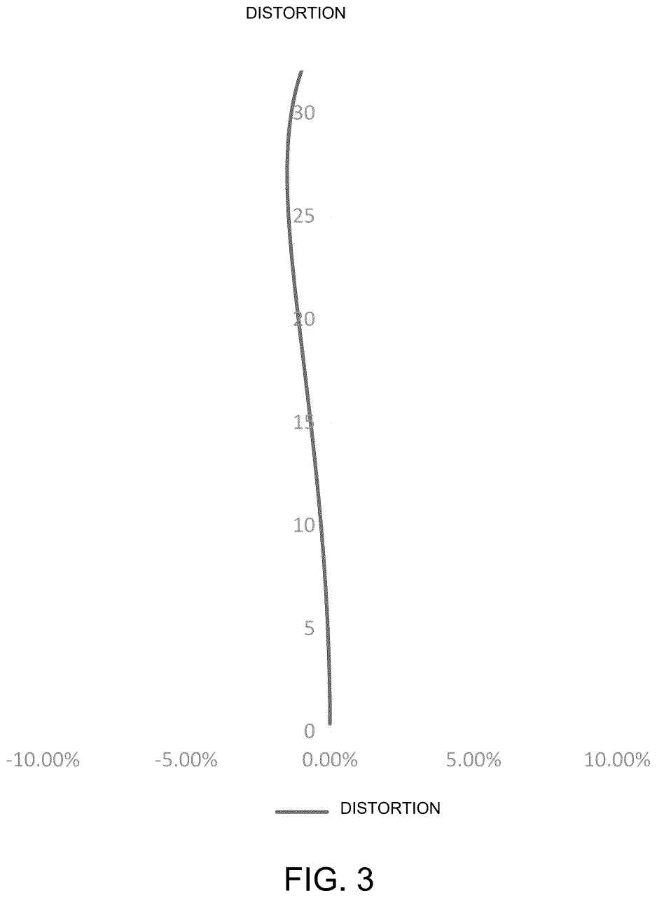

In some embodiments, as may be seen from FIG. 2 and FIG. 3, the meridian (corresponding to T in FIG. 2) and arc vector (corresponding to S in FIG. 2) field curvature of the light produced by the full-frame large-aperture lens may be between −0.2 mm and 0.2 mm; the maximum distortion of the full-frame large-aperture lens may be less than 2%, as seen in FIG. 3.

It should be pointed out that the full-frame large-aperture lens adopts an integrated design to achieve miniaturization of the lens while obtaining excellent optical performance with high resolution, low breathing and low distortion. It may be designed to match the camera mounts of various brands on the market according to actual use requirements, so as to realize personalized customization and general cooperation.

Clearly, the above examples are provided to illustrate the points made and are not intended to limit the scope of the implementation methods. Those skilled in the art may make various changes or variations based on the above description. It may be neither necessary nor possible to exhaust all possible implementations. Any obvious changes or variations that arise from these are still within the scope of protection of this invention.

What is claimed is:

1. A full-frame large-aperture lens comprising:
a first lens group (G1);
a second lens group (G2);
a third lens group (G3); and
a fourth lens group (G4) arranged sequentially from an object side to an image side along an optical axis; a focal length of each of lens groups satisfies the following condition formula:
−3.2<f(G1)/f(G2−G4)<−1.7;
−3.4<f(G3)/f(G2−G4)<−1.9;
−3.3<f(G1)/f<−1.8; and
1.3<f(G4)/f(G2−G4)<2.5;
wherein, f(G1) represents a focal length of the first lens group (G1), f(G2−G4) represents a combined focal length of the second lens group (G2) to the fourth lens group (G4), f(G3) represents a focal length of the third lens group (G3), f(G4) represents a focal length of the fourth lens group (G4), and f represents a combined focal length of all lens groups.

2. The full-frame large-aperture lens of claim 1, wherein the aperture is configured to be disposed between the first lens group (G1) and the second lens group (G2), and the third lens group (G3) is configured move along the optical axis direction.

3. The full-frame large-aperture lens of claim 1, wherein the first lens group (G1) comprises a first lens (1), a second lens (2), a third lens (3), a fourth lens (4), a fifth lens (5), a sixth lens (6), and a seventh lens (7), wherein the lens, the second lens, the third lens, the fourth lens, the fifth lens, the sixth lens, and the seventh lens are configured to be arranged sequentially from the object side to the image side along the optical axis;
wherein the first lens (1) comprises a crescent-shaped negative refractive power lens with a convex surface facing the object side;
wherein the second lens (2) comprises a crescent-shaped positive refractive power lens with a convex surface facing the object side;
wherein the third lens (3) comprises a crescent-shaped negative refractive power lens with a convex surface facing the object side;
wherein the fourth lens (4) comprises a crescent-shaped negative refractive power lens with a convex surface facing the image side;
wherein the fifth lens (5) comprises a double convex positive focal power lens;
wherein the sixth lens (6) comprises a double concave negative optical power lens;
wherein the seventh lens (7) comprises a double convex positive focal power lens;
wherein the second lens (2) and the third lens (3) are bonded together on their adjacent side; and the sixth lens (6) and the seventh lens (7) are bonded together on their adjacent side.

4. The full-frame large-aperture lens of claim 3, wherein the second lens group (G2) comprises an eighth lens (8); the eighth lens (8) includes a double convex positive refractive power lens.

5. The full-frame large-aperture lens of claim 4, wherein the third lens group (G3) comprises a ninth lens (9) having a crescent-shaped negative light focal power lens with a convex surface facing the object side.

6. The full-frame large-aperture lens of claim 5, wherein the fourth lens group (G4), comprising a tenth lens (10), an eleventh lens (11), a twelfth lens (12), a thirteenth lens (13), a fourteenth lens (14), a fifteenth lens (15), and a sixteenth lens (16) arranged sequentially from the object side to the image side along the optical axis;
wherein the tenth lens (10) comprises a crescent-shaped negative refractive power lens with a convex surface facing the object side;
wherein the eleventh lens (11) comprises a double convex positive focal power lens;
wherein the twelfth lens (12) comprises a double convex positive focal power lens;
wherein the thirteenth lens (13) comprises a double concave positive focal power lens;
wherein the fourteenth lens (14) comprises a crescent positive focal lens;
wherein the fifteenth lens (15) comprises a double convex positive focal power lens;
wherein the sixteenth lens (16) comprises a double concave positive focal power lens;
wherein the tenth lens (10) and the eleventh lens (11) are bonded together on their adjacent side; the twelfth lens (12) and the thirteenth lens (13) are bonded together on their adjacent side; and the fifteenth lens (15) and the sixteenth lens (16) are bonded together on their adjacent side.

7. The full-frame large-aperture lens of claim 6, wherein the fifth lens (5), the ninth lens (9), and the fourteenth lens (14) comprise aspherical lenses, wherein the first lens (1), the second lens (2), the third lens (3), the fourth lens (4), the sixth lens (6), the seventh lens (7), the eighth lens (8), the tenth lens (10), the eleventh lens (11), the twelfth lens (12), and the thirteenth lens (13) comprise spherical lenses.

8. The full-frame large-aperture lens of claim 1, wherein the aperture of the full-frame large-aperture lens comprises 1 to 1.6, and the field of view angle 2ω of the full-frame large-aperture lens comprise 55° to 75°.

9. The full-frame large-aperture lens of claim 1, wherein the focal length of the full-frame large-aperture lens comprises 20 mm to 40 mm.

10. The full-frame large-aperture lens of claim 1, wherein the total optical length of the full-frame large-aperture lens comprises no more than 110 mm.
